(19) United States
(12) Patent Application Publication
(10) Pub. No.: US 2025/0123370 A1
(43) Pub. Date: Apr. 17, 2025

(54) RADAR CONTROL METHOD, DEVICE, TERMINAL EQUIPMENT AND STORAGE MEDIUM

(71) Applicant: SUTENG INNOVATION TECHNOLOGY CO., LTD., Shenzhen (CN)

(72) Inventor: Changsheng GONG, Shenzhen (CN)

(73) Assignee: SUTENG INNOVATION TECHNOLOGY CO., LTD., Shenzhen (CN)

(21) Appl. No.: 18/898,630

(22) Filed: Sep. 26, 2024

(30) Foreign Application Priority Data
Oct. 12, 2023 (CN) 202311323118.3

(51) Int. Cl. G01S 7/481; G01S 17/89

(52) U.S. Cl. CPC G01S 7/4817; G01S 17/89

(57) ABSTRACT

The present application provides a radar control method, apparatus, terminal device and storage medium. The method includes: after completing an emission and reception of a frame of signals, adjusting a scanning order of a LiDAR, so that a scanning order of a current frame of the LiDAR is not all the same as a scanning order of a previous frame of signal; controlling the LiDAR to perform an operation of emission and reception on the next frame of signal according to the adjusted scanning order.

### CROSS-REFERENCE TO RELATED APPLICATION

The present application claims the benefit of priority to Chinese Patent Application No. 202311323118.3, filed on Oct. 12, 2023, which is hereby incorporated by reference in its entirety.

### TECHNICAL FIELD

The present application relates to the technical field of radar systems, and in particular, relates to a radar control method, apparatus, terminal equipment and storage medium.

### TECHNICAL BACKGROUND

LiDAR systems are often used in autonomous driving, logistics vehicles, robots, public smart transportation and other fields, due to their high resolution, high sensitivity, strong anti-interference ability, and not being affected by dark conditions.

For area array LiDAR, multiple emitting units and multiple receiving units work at the same time. When there are multiple LiDAR working in the same scanning mode, greater interference will be generated, have the problem of insufficient anti-interference ability.

### SUMMARY

Embodiments of the present application provide a radar control method, apparatus, terminal device and storage medium, which can improve the anti-interference ability of LiDAR.

In a first aspect, an embodiment of the present application provides a radar control method, including: after completing an emission and reception of a frame of signal, adjusting a scanning order of a LiDAR, so that a scanning order of a current frame of the LiDAR is not all the same as a scanning order of a previous frame of signal; controlling the LiDAR to perform operation of emission and reception on a next frame signal, according to the adjusted scanning order.

In an embodiment, after completing an emission and reception of a frame of signal, adjusting a scanning order of a LiDAR, the method includes: adjusting a scanning time interval;
accordingly, controlling the LiDAR to perform operation of emission and reception on a next frame signal, according to the adjusted scanning order includes:
controlling the LiDAR to perform operation of emission and reception on a next frame signal, according to the adjusted scanning order and the adjusted scanning time interval.

In an embodiment, after completing an emission and reception of a frame of signal, adjusting a scanning order of a LiDAR, the method includes: adjusting time intervals of multiple emissions and receptions within the LiDAR frame, so that the time intervals of multiple emissions and receptions are partially or all different.

In an embodiment, after completing an emission and reception of a frame of signal, adjusting a scanning order of a LiDAR includes: adjusting an emission order of an emitting unit of the LiDAR and/or adjusting a reception order of a receiving unit of the LiDAR emission.

In an embodiment, the adjusting the scanning time interval includes: adjusting an emission time interval between frames and/or adjusting an emission and reception time interval within each frame.

In an embodiment, the adjusting an emission and reception time interval within each frame includes: adjusting an emission time interval between two emit blocks in each frame and/or adjusting a reception time interval between two receive blocks in each frame.

In an embodiment, the adjusting an emission time interval between frames includes: adjusting a start emission time of each frame or adjusting a start emission time of part of the frames, so that the start emission time intervals between two frames are different.

In a second aspect, an embodiment of the present application provides a radar control device, including: a first adjustment unit, configured to adjust a scanning order of a LiDAR, after completing an emission and reception of a frame of signal, so that a scanning order of a current frame of the LiDAR is not all the same as a scanning order of a previous frame of signal;
a control unit, configured to control the LiDAR to perform operation of emission and reception on a next frame signal, according to the adjusted scanning order.

In a third aspect, an embodiment of the present application provides a terminal device, including a processor, a memory, and a computer program stored in the memory and executable on the processor, where when the processor executes the computer program, the method embodiments are implemented.

In a fourth aspect, an embodiment of the present application provides a computer-readable storage medium, where the computer-readable storage medium stores a computer program, and when the computer program is executed by a processor, the method embodiments are implemented.

In a fifth aspect, an embodiment of the present application provides a computer program product. When the computer program product runs on a terminal device, the terminal device executes the method embodiments.

By adjusting the scanning order of the LiDAR after completing the emission of a frame of signal, the scanning order of the current frame signal is not exactly the same as the scanning order of the previous frame signal, thereby reducing the interference between radars caused by overlapping scanning tracks and improving the radar's anti-interference ability.

### BRIEF DESCRIPTION OF DRAWINGS

In order to more clearly illustrate the technical solutions in the embodiments of the present application, the drawings used in the embodiments will be briefly introduced below. The drawings described below are only some embodiments.

FIG. 1 is a schematic diagram of the structure of an emitting unit and a receiving unit of a radar provided in an embodiment;

FIG. 2 is a schematic diagram of a scanning order and scanning trajectory of an emitting unit of a radar provided in an embodiment;

FIG. 3 is a schematic diagram of an implementation flow of a radar control method provided by an embodiment;

FIG. 4 is a schematic diagram of the structure of a radar corresponding to a radar control method provided in an embodiment;

FIG. 5 is a schematic diagram of the structure of another radar data processing device provided in an embodiment;

FIG. 6 is a schematic diagram of an implementation flow of another radar control method provided in an embodiment;

FIG. 7 is a timing diagram of the emission time interval between emission blocks provided in an embodiment;

FIG. 8 is a timing diagram corresponding to the time interval between the start emission times of frames provided in an embodiment;

FIG. 9 is a timing diagram of a time interval between a start emission time of the frames and an emission time interval between the emission blocks provided in an embodiment;

FIG. 10 is a schematic diagram of the structure of a radar corresponding to another radar control method provided in an embodiment;

FIG. 11 is a schematic diagram of an implementation flow of another radar control method provided in an embodiment;

FIG. 12 is a schematic diagram of the timing of multiple emissions and receptions in the radar control method provided in an embodiment;

FIG. 13 is a schematic diagram of the structure of a radar corresponding to another radar control method provided in an embodiment;

FIG. 14 is a schematic diagram of an implementation flow of another radar control method provided in an embodiment;

FIG. 15 is a schematic diagram of the structure of a radar corresponding to another radar control method provided in an embodiment;

FIG. 16 is a schematic diagram of the structure of a radar control device provided in an embodiment;

FIG. 17 is a schematic diagram of the structure of a terminal device provided in an embodiment; and

FIG. 18 is a schematic diagram of the structure of a computer-readable storage medium provided in an embodiment.

### DETAILED DESCRIPTION

In the following description, details such as specific system structures, technologies, etc., are provided for the purpose of illustration, so as to provide a thorough understanding of the embodiments. In other cases, detailed descriptions of well-known systems, devices, circuits, and methods are omitted to prevent unnecessary details from obstructing the description of the present application.

The term “and/or” used in the specification and the appended claims refers to any combination of one or more of the associated listed items and all possible combinations, and includes these combinations. In addition, in the description of the specification and the appended claims, the terms “first,” “second,” “third,” etc., are only used to distinguish the description and cannot be understood as indicating or implying relative importance.

References to “an embodiment” or “some embodiments” etc., described in the specification mean that one or more embodiments of the present application include specific features, structures or characteristics described in conjunction with the embodiment. Thus, the statements “in one embodiment,” “in some embodiments,” “in some other embodiments,” “in some other embodiments,” etc., that appear in different places in the specification do not necessarily refer to the same embodiment, but mean “one or more but not all embodiments,” unless otherwise emphasized in other ways. The terms “including,” “comprising,” “having,” and their variations all mean “including but not limited to,” unless otherwise emphasized in other ways.

A radar system has an emitting unit and a receiving unit. The emitting unit can emit a detection signal. When the detection signal reaches a target object, an echo signal reflected by the target object can be received by the receiving unit. The radar system can obtain the corresponding observation results based on the received echo signal.

For an array-type LiDAR, its emitting unit includes multiple emitting blocks, and its receiving unit includes multiple receiving blocks, and the emitting blocks and receiving blocks can be set up with corresponding emitting and receiving relationships, the echo signal corresponding to the detection signal emitted by a certain emitting block can be received by one or several receiving blocks corresponding to it.

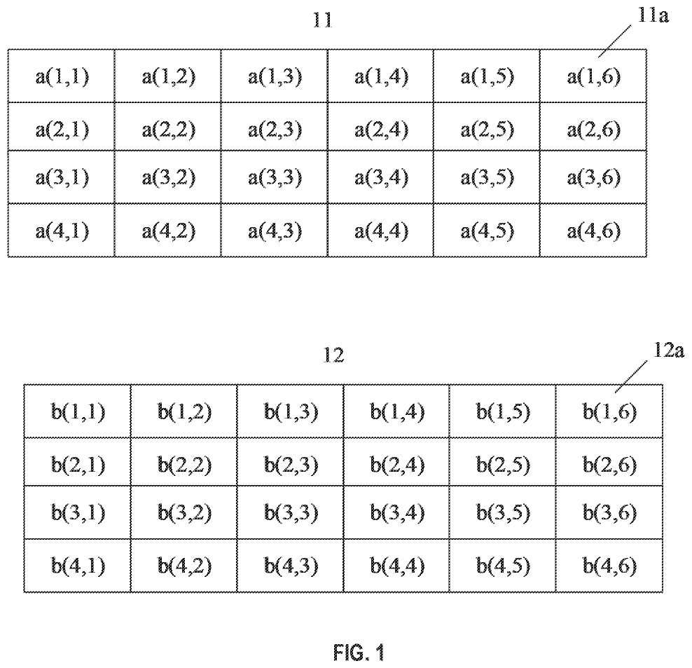

Exemplarily, an emitting unit 11 of an array-type LiDAR includes an emitting block 11a of N rows and M columns, and correspondingly, the receiving unit 12 of the array-type LiDAR may include a receiving block 12a of N rows and M columns. As shown in FIG. 1, the emitting unit 11 of the LiDAR in FIG. 1 includes 4*6 emitting blocks 11a, and the receiving unit 12 includes 4*6 receiving blocks 12a. a(1,1) represents an emitting position of the emitting block, for example, a(1,1) represents the emitting block corresponding to the first row and first column in the emitting unit, a(2,1) represents the emitting block corresponding to the second row and first column in the emitting unit, and so on. b(1,1) represents a receiving position of the receiving block, for example, b(1,1) represents the receiving block corresponding to the first row and first column in the receiving unit, b(2,1) represents the receiving block corresponding to the second row and first column in the receiving unit, and so on.

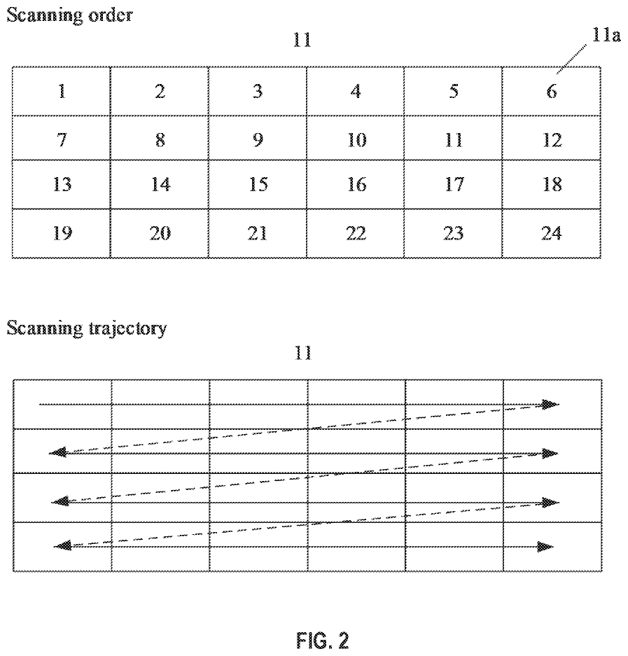

In an embodiment, a scanning order of the array-type LiDAR is fixed. For example, as shown in FIG. 2, corresponding to a scanning order position of an emitting unit array in FIG. 2, a scanning trajectory of the emitting unit is shown in FIG. 2, that is, the first row of scanning is completed first, then the second row of scanning is completed, and then the third row of scanning is completed, and so on. After completing a frame of scanning, the above scanning trajectory is repeated again to scan the next frame.

When there are multiple (at least two) radars with the same scanning mode, interference between the detection signals emitted by the radars is likely to occur. The most serious interference is when the scanning tracks of the two radars all overlap.

An embodiment of the present application provides a radar control method, which can adjust the scanning order of the LiDAR after completing the emission of a frame of signal, so that the scanning order of the current frame signal is not exactly the same as the scanning order of the previous frame signal, thereby reducing the interference between radars caused by overlapping scanning trajectories and improving the anti-interference ability of the radar.

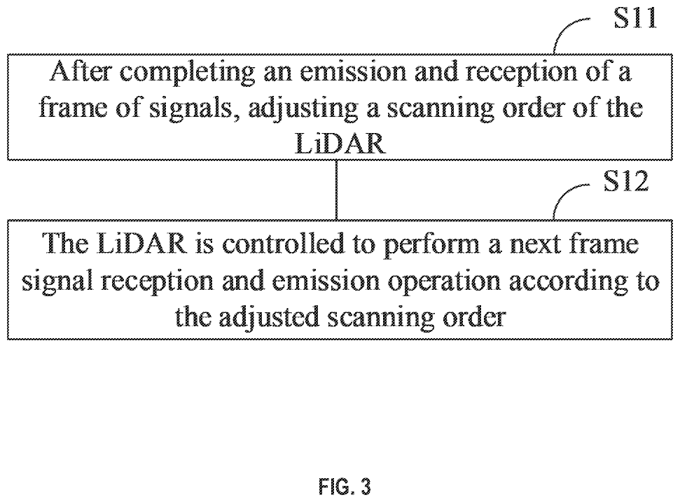

Refer to FIG. 3, which is a schematic flow chart of a radar control method provided in an embodiment. An execution subject of the radar control method provided in an embodiment can be a control system inside the LiDAR, such as a transceiver control unit, a main control chip, etc., or a terminal device connected to the LiDAR for communication. The above-mentioned terminal device can be a mobile phone, desktop computer, laptop computer, tablet computer or wearable device, etc., or it can be a cloud server, radar auxiliary computer and other devices in various application scenarios. The radar control method provided in an embodiment is mainly applicable to planar LiDAR products and array-type LiDAR products. The following is an example in which the execution subject is a control system inside the LiDAR. As shown in FIG. 3, the above-mentioned radar control method may include S11 to S12.

In S11, after completing an emission and reception of a frame of signals, adjusting a scanning order of the LiDAR.

In an embodiment, completing one frame of signal emission and reception means that the emitting unit of the LiDAR completes one frame of signal emission and the receiving unit of the LiDAR completes one signal reception; where each emitting block in the emitting unit of the LiDAR completes one signal emission and is deemed to complete one frame of signal emission, and each receiving block in the receiving unit of the LiDAR completes the corresponding signal reception and is deemed to complete one frame of signal reception.

In an embodiment, a scanning order of the LiDAR is adjusted so that the scanning order of the current frame of the LiDAR is adjusted to be not all the same as the scanning order of the previous frame signal.

Here, the above-mentioned adjustment of the scanning order of the LiDAR includes adjusting the emission order of the emitting unit of the LiDAR and/or adjusting the receiving order of the receiving unit of the LiDAR.

In an embodiment, adjusting the emission order of the LiDAR's emitting unit may be adjusting an emission position of each emitting block in the emitting unit. Adjusting the receiving order of the LiDAR's receiving unit may also be adjusting a receiving position corresponding to each receiving block (for example, adjusting which receiving block receives the echo signal corresponding to the detection signal emitted by which receiving block, etc.).

The adjustment of the scanning order of the LiDAR can be to adjust the emission position of the emission block in the emission unit of the LiDAR to achieve the purpose of adjusting the emission order of the emission unit, or it can be to adjust the receiving position of the receiving block in the receiving unit of the LiDAR to achieve the purpose of adjusting the receiving order of the receiving unit, or it can be to adjust the emission position of the emission block in the emission unit and adjust the receiving position of the receiving block in the receiving unit at the same time, so as to achieve the purpose of simultaneously adjusting the emission order of the emission unit and adjusting the receiving order of the receiving unit.

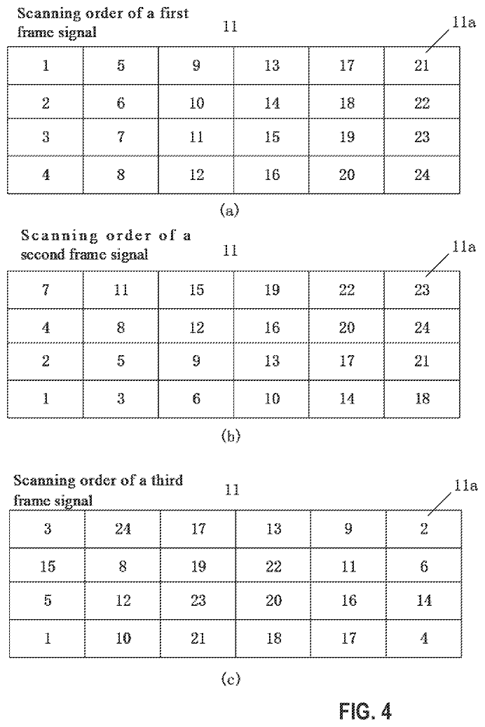

As shown in FIG. 4, taking adjusting the emission order of the LiDAR's emission unit as an example, during a first frame scan, the emission position of each emission block in the emission unit is as shown in (a) in FIG. 4. After completing the first frame of signal emission and reception, the emission order of the LiDAR's emission unit is adjusted, and the emission position of each emission block in the emission unit corresponding to a second frame is as shown in (b) in FIG. 4. After completing a second frame of signal emission and reception, the scanning order of the LiDAR's emission unit can be adjusted again to obtain the scanning order of the emission unit corresponding to a third frame, that is, the emission control can be performed according to the emission position of each emission block as shown in (c) in FIG. 4.

In an embodiment, the more random the position adjustment of the emitting block in the emitting unit of the LiDAR, or the more random the position adjustment of the receiving block in the receiving unit, the stronger the anti-interference ability of the LiDAR.

In an embodiment, each emitting block in the emitting unit of the LiDAR can independently use a different emitting time interval, and each receiving block in the receiving unit can receive and process synchronously with the emission of the corresponding emitting block.

In S12, the LiDAR is controlled to perform a next frame signal reception and emission operation according to the adjusted scanning order.

In an embodiment, after the LiDAR completes a scanning order adjustment, the emitting unit of the LiDAR can be controlled to emit the detection signal according to the adjusted scanning order, and the corresponding echo signal can be received through the receiving unit.

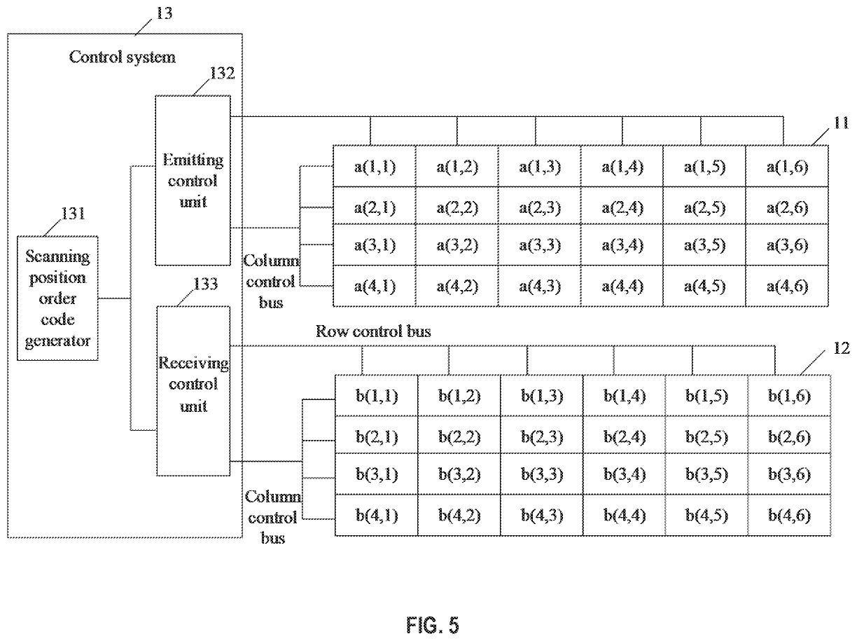

FIG. 5 shows a schematic diagram of the structure of a LiDAR. As shown in FIG. 5, the LiDAR 10 may include an emitting unit 11, a receiving unit 12, and a control system 13. The control system 13 may include a scanning position order code generator 131, an emitting control unit 132, and a receiving control unit 133.

The scanning position order code generator 131 is used to generate an emission position code of an emitting unit and/or a receiving position code of a receiving unit.

The scanning position order code generator 131 may generate the scanning position code corresponding to each frame in advance (which may include the emission position code and/or the reception position code), and then send the generated scanning position code to the control unit (that is, when generating the emission position code, the emission position code is sent to the emitting control unit 132, and when generating the reception position code, the reception position code is sent to the receiving control unit 133). Alternatively, the scanning position order code generator 131 may generate the corresponding scanning position code for the next frame signal in real time after receiving the indication of completing the emission and reception of the previous frame.

The emitting control unit 132 is used to control the emission unit to emit a detection signal according to the emission position code. For example, for the emitting unit 11 in FIG. 5, the emitting control unit 132 can first control the emission block with the position code a(1,1) to emit the detection signal, and then control the emission block with the position code a(1,2) to emit the detection signal. After the emission block with the position code a(1,6) is emitted, the emission block with the position code a(2,1) is controlled to emit a detection signal, and so on.

The receiving control unit 133 is used to control a receiving block to receive an echo signal according to the receiving position code. For example, in the receiving unit 12 in FIG. 5, the receiving control unit 133 first controls the receiving block with the position code b(1,1) to receive the echo signal corresponding to the detection signal emitted by the emitting block b(1,1), and then controls the receiving block with the position code b(1,2) to receive the echo signal. After the receiving block with the position code b(1,6) completes the reception, the receiving block with the position code b(2,1) is controlled to receive the echo signal, and so on.

The radar control method provided in an embodiment can adjust the scanning order of the LiDAR after completing the emission of a frame of signal, so that the scanning order of the next frame of signal is not exactly the same as the scanning order of the previous frame of signal, thereby reducing the interference between radars caused by overlapping scanning trajectories and improving the anti-interference ability of the radar.

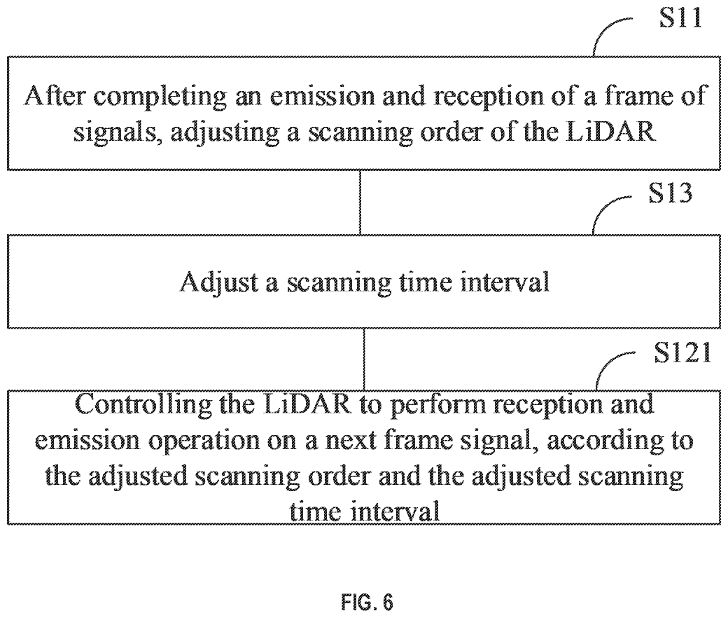

Refer to FIG. 6, which is a schematic diagram of the implementation flow of another radar control method provided in an embodiment. As shown in FIG. 6, the radar control method includes the following steps after S11:
S13: adjust a scanning time interval.

Correspondingly, the above S12 may include S121. S121: controlling the LiDAR to perform reception and emission operation on a next frame signal, according to the adjusted scanning order and the adjusted scanning time interval.

In an embodiment, on the basis of adjusting the emission position of the emitting block of the LiDAR and/or adjusting the receiving position of the receiving block, the scanning time interval is adjusted to further improve the anti-interference ability of the radar.

In an embodiment, the adjustment of the scanning time interval includes adjusting an emission time interval between frames and/or adjusting an emission and reception time interval within each frame.

The adjustment of the emission and reception time interval in each frame includes adjusting the emission time interval between every two emission blocks in each frame and/or adjusting the reception time interval between every two reception blocks in each frame.

In an embodiment, the emission time interval between every two emission blocks in each frame is adjusted, so that the emission time intervals between any two emission blocks are partially or all different, and the receiving time interval between every two receiving blocks in each frame is adjusted, so that the receiving time intervals between any two receiving blocks are partially or all different.

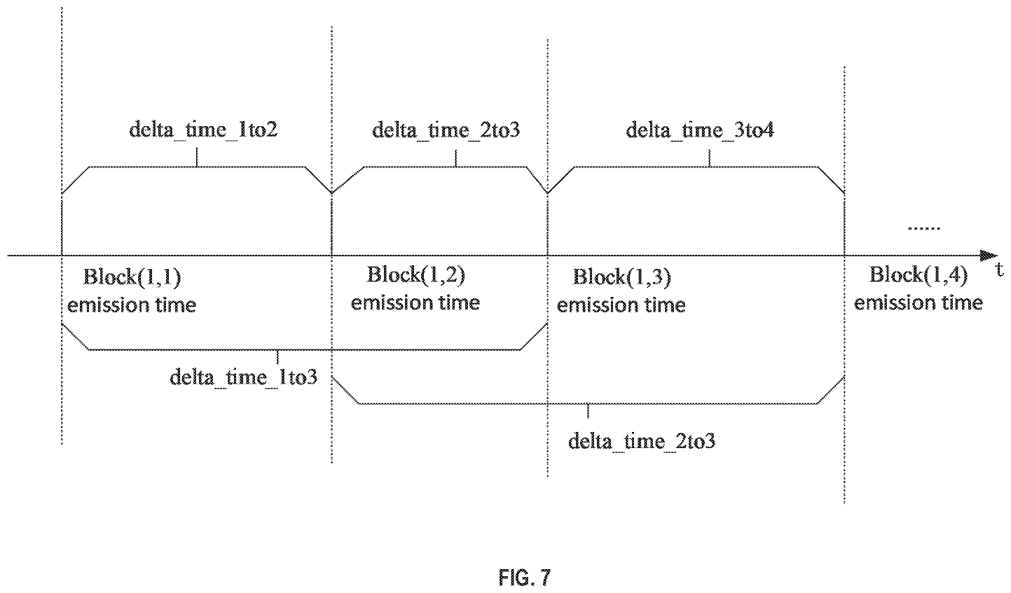

Exemplarily, taking adjusting an emission time interval between every two emission blocks in each frame as an example, as shown in FIG. 7, delta_time_1to2 refers to a time difference between the emission time of emission block Block(1,1) and the emission time of emission block Block(1,2); delta_time_2to3 refers to a time difference between the emission time of emission block Block(1,2) and the emission time of emission block Block(1,3), and so on. By adjusting the emission time interval, delta_time_1to2, delta_time_2to3, delta_time_3to4, etc., are partially or all different.

In an embodiment, the emission time intervals between emission blocks separated by two or more blocks may also be adjusted to be different, for example, by adjusting the emission time intervals so that emission time intervals such as delta_time_1to3, delta_time_2to4, delta_time_3to5 are partially or all different, where delta_time_1to3 refers to the time difference between the emission moment of emission block Block(1,1) and the emission moment of emission block Block(1,3), and delta_time_2to4 refers to the time difference between the emission moment of emission block Block(1,2) and the emission moment of emission block Block(1,4). By analogy, the emission interval times of other interval block numbers can also be adjusted to be partially or all different.

Regarding the adjustment of the receiving time interval between receiving blocks, reference can also be made to the description of the adjustment of the emitting time interval of the emitting block.

In an embodiment, the more different the emitting and receiving time intervals (including the emitting time interval and/or the receiving time interval) are, the better the radar's anti-interference ability is.

In an embodiment, the adjustment of the emission time interval between frames may be to adjust a start emission time of each frame, so that the start emission time interval between two frames is different, or to adjust a start emission time of some frames, so that the start emission time interval between two frames is different.

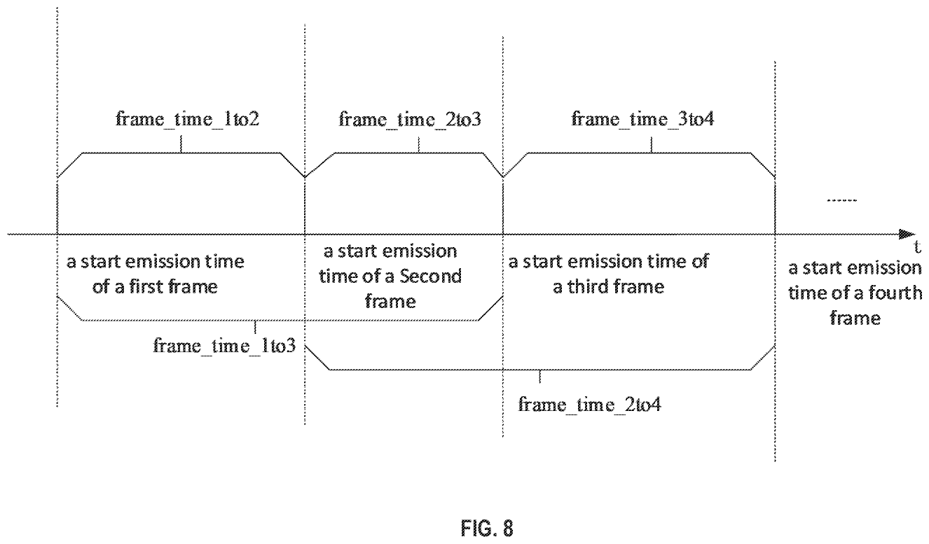

For example, as shown in FIG. 8, frame_time_1to2 refers to a time difference between a start emission time of a first frame and a start emission time of a second frame; frame_time_2to3 refers to a time difference between a start emission time of the second frame and a start emission time of a third frame, and so on. By adjusting the emission time interval between frames, the emission time intervals between two frames such as frame_time_1to2, frame_time_2to3, frame_time_3to4, etc., are partially or all different.

In some embodiments, the emission time interval between the interval frames can be adjusted to achieve the adjustment of the emission time interval between frames, for example, by adjusting a start emission time of the frame, so that the emission time intervals such as frame_time_1to 3, frame_time_2to 4, frame_time_3to 5, etc., are partially or all different. frame_time_1to3 refers to the time difference between the start emission time of the first frame and the start emission time of the third frame; frame_time_2to 4 refers to the time difference between the start emission time of the second frame and the start emission time of the fourth frame, and frame_time_3to 5 refers to the time difference between the start emission time of the second frame and the start emission time of the fourth frame. The emission interval time of other interval block numbers can be adjusted to be partially or all different.

In an embodiment, the more different the emission time intervals between two frames are, the better the radar's anti-interference ability is.

In an embodiment, the emission time interval between frames is adjusted while adjusting the emission and reception time interval within each frame, a start emission time of each frame can be adjusted, and an emission time of each emission block or the reception time of each reception block in each frame can be adjusted.

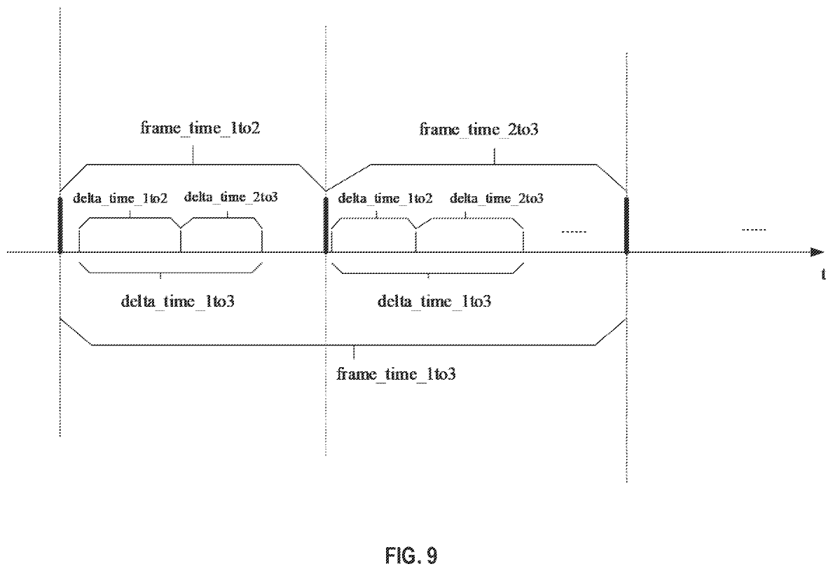

Exemplarily, as shown in FIG. 9, frame_time_1to2 refers to a time difference between a start emission time of a first frame and a start emission time of a second frame, frame_time_2to3 refers to a time difference between the start emission time of the second frame and a start emission time of a third frame, and frame_time_3to4 refers to a time difference between the start emission time of the third frame and a start emission time of a fourth frame. The start emission time intervals between the two frames are adjusted to be partially or all different, that is, frame_time_1to2, frame_time_2to3, frame_time_3to4 . . . are set to be partially or all different.

Frame_time_1to3 refers to the time difference between the start emission time of the 1st frame and the start emission time of the 3rd frame, frame_time_2to4 refers to the time difference between the start emission time of the 2nd frame and the start emission time of the 4th frame, and frame_time_3to5 refers to the time difference between the start emission time of the 2nd frame and the start emission time of the 4th frame. Adjust the emission time intervals between the interval frames to be partially or all different, that is, set frame_time_1to 3, frame_time_2to 4, frame_time_3to 5, etc., to be partially or all different. Similarly, the interval time of other interval frames can be set to be partially or all different.

delta_time_1to2 refers to a time difference between an emission time of emission block Block(1,1) and an emission time of emission block Block(1,2); delta_time_2to3 refers to a time difference between the emission time of emission block Block(1,2) and an emission time of emission block Block(1,3), and so on. The interval time between the emission blocks is adjusted to be partially or all different, that is, delta_time_1to2, delta_time_2to3 and other such time intervals are set to be partially or all different.

delta_time_1to3 refers to the time difference between the emission time of the emission block Block(1,1) and the emission time of the emission block Block(1,3); delta_time_2to4 refers to the time difference between the emission time of the emission block Block(1,2) and the emission time of the emission block Block(1,4), and so on. Adjust the emission time intervals between the interval blocks to be partially or all different, that is, set delta_time_1to3, delta_time_2to4, delta_time_3to5 and other time intervals to be partially or all different. The interval times of other interval blocks can also be set to be partially or all different.

In some embodiments, an interval time between two blocks in different frames can be set to be the same or different. For example, [delta_time_1to2, delta_time_2to3, delta_time_3to4 . . . ] in the first frame and [delta_time_1to2, delta_time_2to3, delta_time_3to4 . . . ] in the second frame can be set to be different, and [delta_time_1to3, delta_time_2to4, delta_time_3to5 . . . ] in the first frame and [delta_time_1to3, delta_time_2to4, delta_time_3to5 . . . ] in the second frame can also be set to be different; when the time between blocks in every two frames is also different, the anti-interference ability of the LiDAR will be stronger.

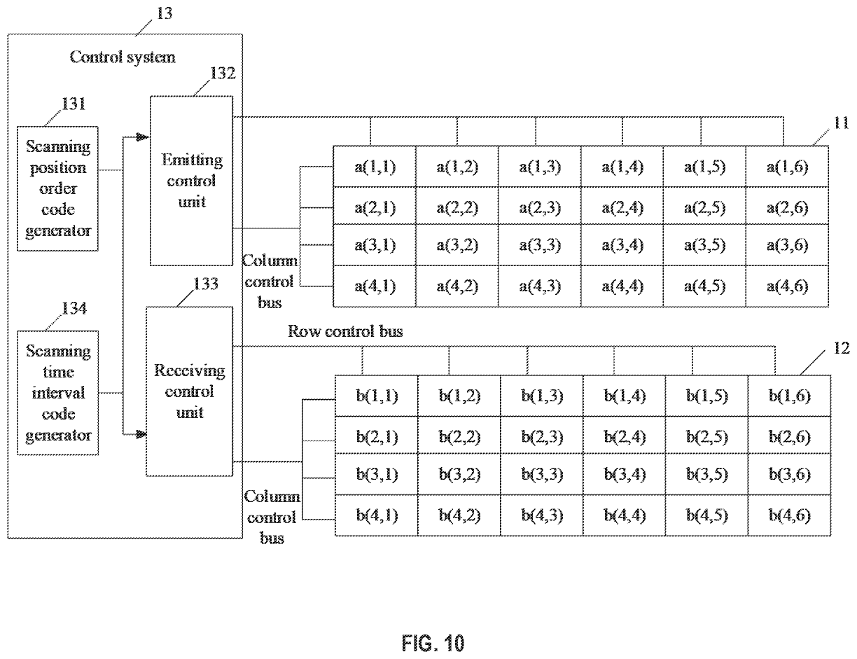

FIG. 10 shows a schematic diagram of the structure of a LiDAR. As shown in FIG. 10, the LiDAR 10 may include an emitting unit 11, a receiving unit 12, and a control system 13. The control system 13 may include a scanning position order code generator 131, an emitting control unit 132, a receiving control unit 133, and a scanning time interval code generator 134.

For the description of the scanning position order code generator 131, please refer to the relevant description of FIG. 5.

The scanning time interval code generator 134 is used to generate an emission time code of an emission block in the emission unit and/or to generate a reception time code of a reception block in the reception unit.

The scanning time interval code generator 134 can pre-generate an emission start time corresponding to each frame and the emission and reception time interval within each frame, and then send the generated emission time code to the emitting control unit 132, and send the generated reception time code to the receiving control unit 133.

The emitting control unit 132 is also used to control the emission blocks in the emission unit to emit detection signals according to the emission time coding. For example, in the emitting unit 11 in FIG. 10, the emitting control unit 132 can first control the emission block with the position coding a(1,1) to emit the detection signal at its corresponding emission time (the starting emission time of each frame), and then control the emission block with the position coding a(1,2) to emit the detection signal after the interval delta_time_1to 2, and so on. After each emission block in the first frame has completed the emission, the emission of the second frame starts after the interval frame_time_1to2 (that is, the emission block with the position coding a(1,1) is controlled to transmit the detection signal after frame_time_1to2).

The receiving control unit 133 is used to control the receiving block to receive the echo signal corresponding to the receiving time code.

The radar control method provided in an embodiment adjusts the scanning time on the basis of adjusting the scanning position and scanning order, thereby making the scanning trajectory of the LiDAR more random, further reducing the repetition rate with other LiDAR scanning trajectories, and improving the anti-interference ability of the LiDAR.

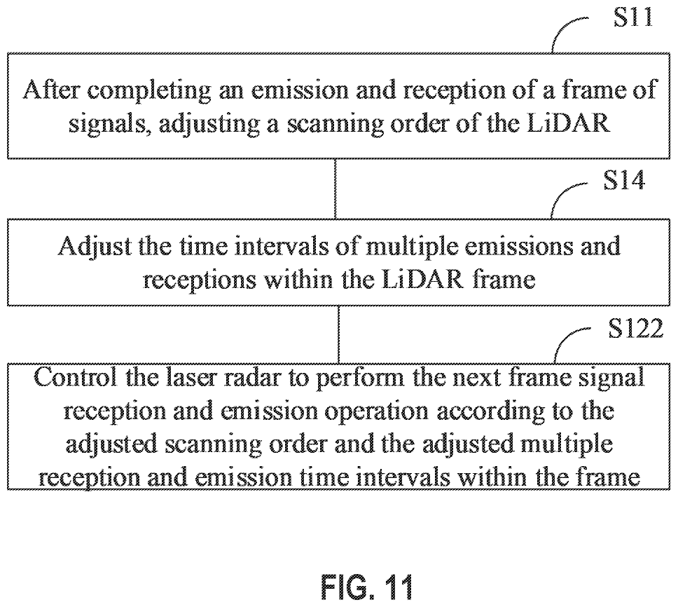

Refer to FIG. 11, which shows a schematic flow chart of another radar control method provided in an embodiment. As shown in FIG. 11, the radar control method provided in an embodiment includes the following steps after S11.
S14: Adjust the time intervals of multiple emissions and receptions within the LiDAR frame.

Accordingly, the above S12 may include S122. S122: Control the laser radar to perform the next frame signal reception and emission operation according to the adjusted scanning order and the adjusted multiple reception and emission time intervals within the frame. In an embodiment, in order to improve the measurement performance and accuracy of the LiDAR, the LiDAR can be controlled to perform multiple reception and emission operations (at least twice) using the same block within one frame, and when determining the measurement results, the multiple received echo signals are superimposed to calculate the measurement results.

In order to improve the anti-interference ability of the LiDAR, the receiving and emitting time intervals of multiple emissions and receptions are adjusted on the basis of adjusting the scanning order of the radar, so that the receiving and emitting time intervals of multiple emissions and receptions are partially or all different.

In an embodiment, the emission and reception time intervals include an emission time interval and a reception time interval, where the emission time interval refers to the time difference between emission times corresponding to different emission times of an emission block, and the reception time interval refers to the time difference between reception times corresponding to different reception times of a reception block.

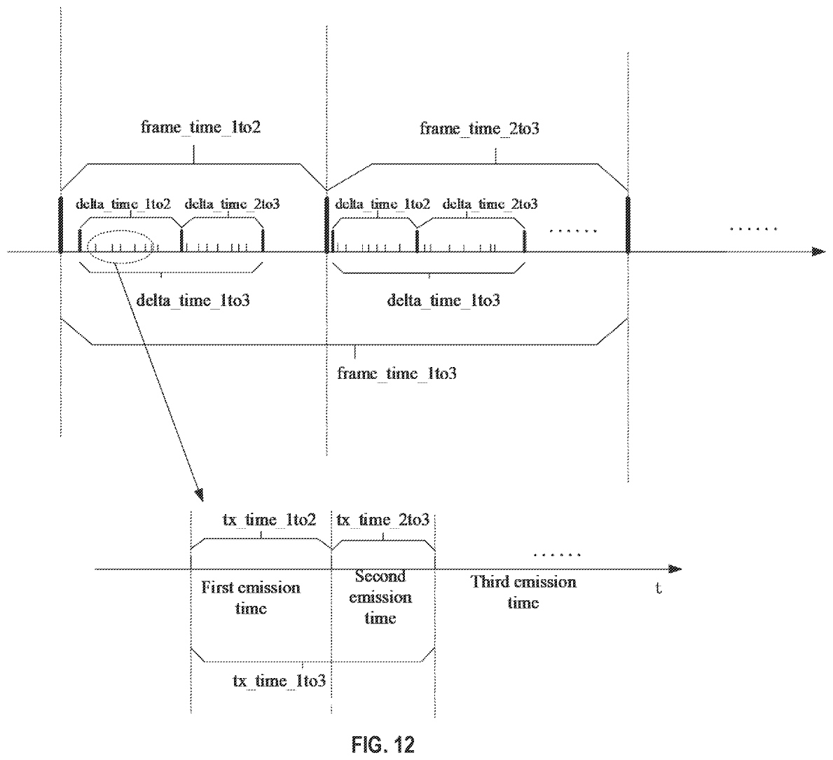

Exemplarily, multiple emissions of an emission block are taken as an example for explanation, as shown in FIG. 12, tx_time_1to2 in FIG. 12 refers to the time difference between the emission time of a first emission and the emission time of a second emission in an emission block; tx_time_2to3 refers to a time difference between the emission time of the second emission and a emission time of the third emission in an emission block. delta_time_1to3 refers to a time difference between the first emission time and the third emission time in an emission block, and so on.

The time intervals between the emission times of two adjacent emissions are adjusted to be partially or all different, that is, tx_time_1to2, tx_time_2to3, tx_time_3to4, etc., are set to be partially or all different.

The emission time intervals of each emission are set to be partially or all different, that is, tx_time_1to3, tx_time_2to4, tx_time_3to5, etc., are set to be partially or all different. Similarly, the time intervals of other times can also be adjusted to be partially or all different.

In an embodiment, the more different the time intervals between two emissions and receptions are, the better the radar's anti-interference ability is.

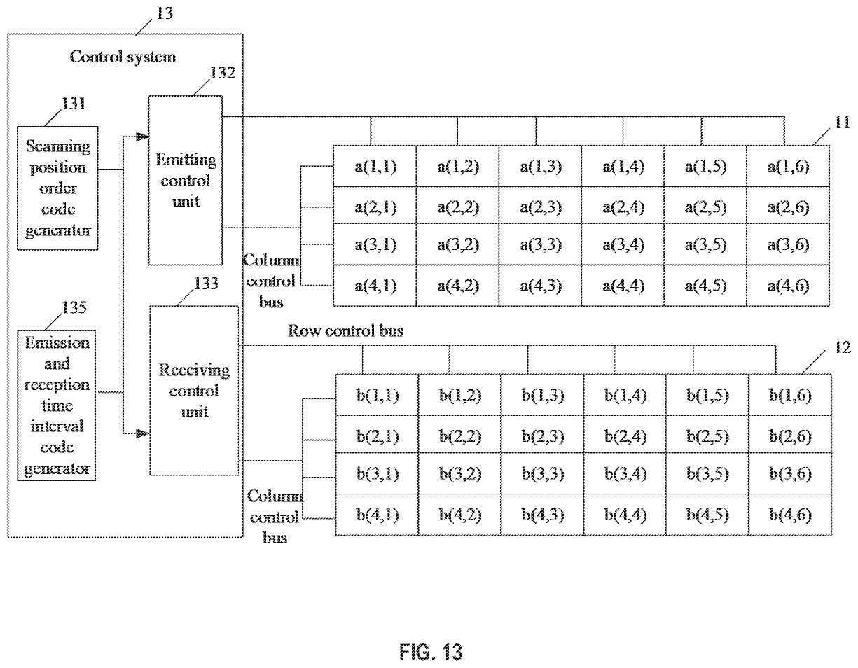

FIG. 13 shows a schematic diagram of the structure of a LiDAR. As shown in FIG. 13, the LiDAR 14 may include an emitting unit 11, a receiving unit 12, and a control system 13. The control system 13 may include a scanning position order code generator 131, an emitting control unit 132, a receiving control unit 133, and an emission and reception time interval code generator 135.

For the description of the scanning position order code generator 131, please refer to the relevant description of FIG. 5.

The emission and reception time interval code generator 135 is used to generate multiple emission time codes of an emission block in the emission unit and/or generate multiple reception time codes of a reception block in the reception unit.

The emission and reception time interval code generator 135 can pre-generate transceiver time codes for multiple emissions and receptions within each frame (including the multiple emission time codes and multiple reception time codes), send the generated multiple emission time codes to the emitting control unit 132, and send the generated multiple reception time codes to the receiving control unit 133.

The emitting control unit 132 is further used to control the emission blocks in the emission unit to emit a detection signal multiple times within one frame according to the multiple emission time codes. For example, in the emitting unit 11 in FIG. 13, the emitting control unit 132 can first control the emission block with the position code (1,1) to emit the detection signal at its corresponding first emission time (the starting emission time of each frame) and emit the detection signal again after the interval tx_time_1to2, and so on.

The receiving control unit 133 is configured to control the receiving block to receive the echo signal multiple times within one frame according to the multiple reception time codes.

Radar control method provided in an embodiment adjusts the time intervals of multiple emissions and receptions on the basis of adjusting the scanning position and scanning order, thereby making the scanning trajectory of the LiDAR more random, reducing the repetition rate with other LiDAR scanning trajectories, and improving the anti-interference ability of the LiDAR.

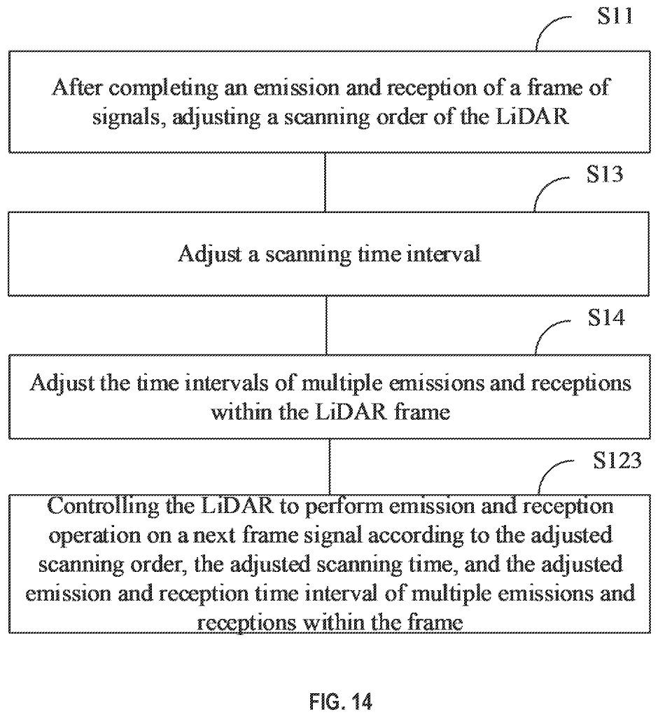

Refer to FIG. 14, which shows a schematic flow chart of another radar control method provided in an embodiment. As shown in FIG. 14, the radar control method provided in the embodiment includes the following steps after S11.
S13: adjusting the scanning time interval.
S14: Adjust the time intervals of multiple emissions and receptions within the LiDAR frame.

Accordingly, the above S12 may include S123. S123: controlling the LiDAR to perform emission and reception operation on a next frame signal according to the adjusted scanning order, the adjusted scanning time, and the adjusted emission and reception time interval of multiple emissions and receptions within the frame.

In an embodiment, after adjusting the scanning order, the scanning time and the time interval between multiple emissions and receptions within a frame may also be adjusted.

The implementation of S13 and S14 can refer to the description of the above embodiment.

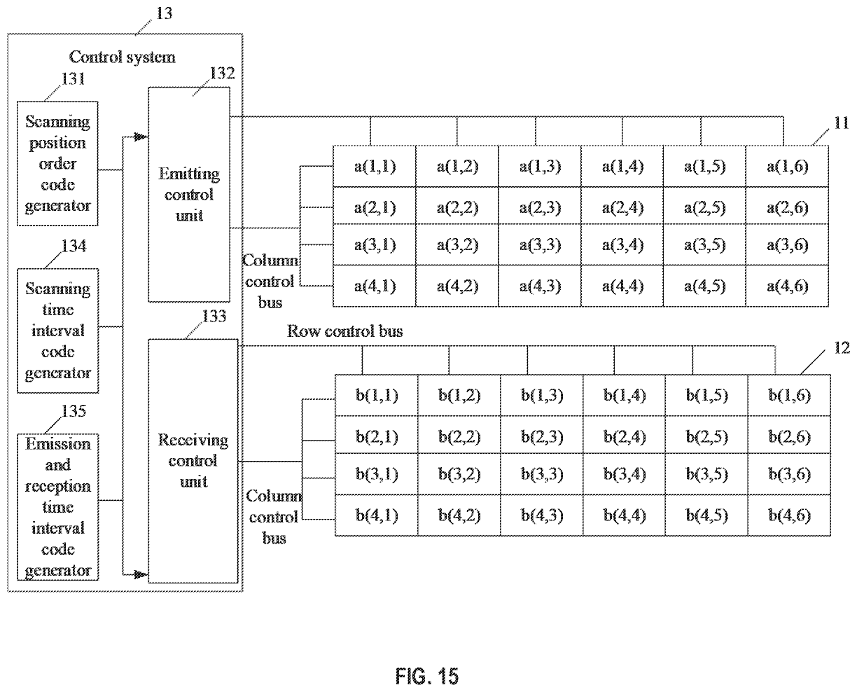

For radar control method provided in an embodiment, FIG. 15 shows a schematic diagram of the structure of a LiDAR. As shown in FIG. 15, the LiDAR 14 may include an emitting unit 11, a receiving unit 12, and a control system 13. The control system 13 may include a scanning position order code generator 131, an emitting control unit 132, a receiving control unit 133, a scanning time interval code generator 134, and an emission and reception time interval code generator 135.

The scanning position order code generator 131, the emitting control unit 132, the receiving control unit 133, the scanning time interval code generator 134 and the emission and reception time interval code generator 135 can refer to the above embodiments.

From the above, the embodiment of the present application combines the scanning order adjustment, the scanning time interval adjustment and the emission and reception time interval adjustment of multiple emissions and receptions, thereby further improving the anti-interference ability of the LiDAR.

The size of the serial numbers of the steps in the above embodiments does not mean the order of execution. The execution order of each process should be determined by its function and internal logic.

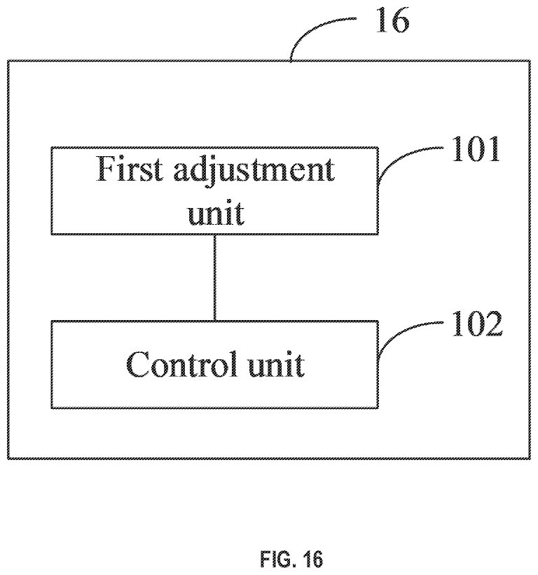

Refer to FIG. 16, which is a schematic diagram of the structure of a radar control device provided in an embodiment. In an embodiment, each unit included in the radar control device is used to execute each step in the embodiment corresponding to FIG. 3. Please refer to FIG. 3 and the relevant description in the embodiment corresponding to FIG. 3 for details. As shown in FIG. 16, the radar control device 16 includes: a first adjustment unit 101 and a control unit 102.

The first adjustment unit 101 is used to adjust the scanning order of the LiDAR after completing the emission and reception of a frame of signals, so that the scanning order of the current frame of the LiDAR is not all the same as the scanning order of the previous frame signal.

The control unit 102 is used to control the LiDAR to perform emission and reception operation on a next frame signal according to the adjusted scanning order.

In some embodiments, the radar control device further includes: a second adjustment unit.

The second adjustment unit is used to adjust a scanning time interval.

Correspondingly, the control unit 102 is used to control the LiDAR to perform emission and reception operation on a next frame signal according to the adjusted scanning order and the adjusted scanning time interval.

In some embodiments, the above-mentioned radar control device also includes: a third adjustment unit.

The third adjustment unit is used to adjust the emission and reception time intervals of multiple emissions and receptions within the LiDAR frame, so that the emission and reception time intervals of multiple emissions and receptions are partially or all different.

In some embodiments, the first adjustment unit 101 is specifically used to adjust the emission order of the emitting unit of the LiDAR and/or adjust the receiving order of the receiving unit of the LiDAR.

In some embodiments, the second adjustment unit is used to adjust the emission time interval between frames and/or adjust the emission and reception time interval within each frame.

The second adjustment unit may include an inter-frame adjustment unit and a block interval time adjustment unit.

In some embodiments, the inter-frame adjustment unit is used to adjust a start emission time of each frame or adjust a start emission time of some frames, so that the start emission time intervals between two frames are different.

In some embodiments, the block interval time adjustment unit is used to adjust an emission time interval between every two emission blocks in each frame and/or adjust a reception time interval between every two reception blocks in each frame.

The information interaction, execution process and other contents between the above-mentioned units are based on the same concept as the method embodiment of the present application. Their functions and technical effects can be found in the method embodiment part and will not be repeated here.

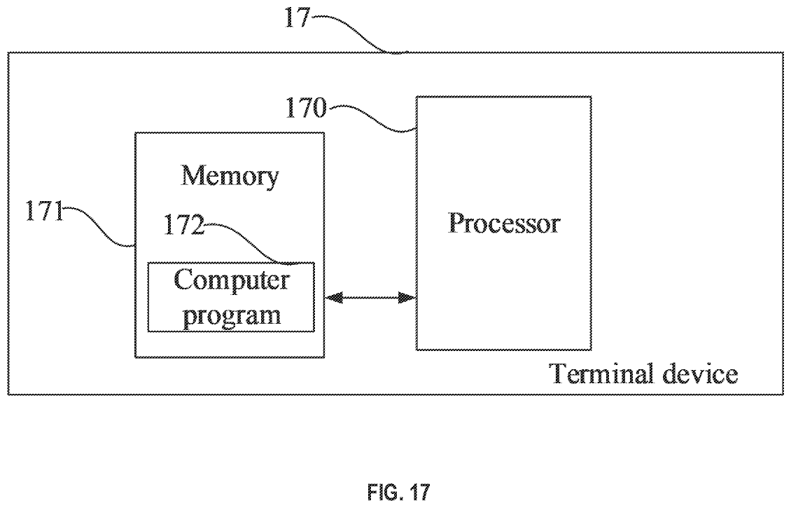

FIG. 17 is a schematic diagram of the structure of a terminal device provided by an embodiment. As shown in FIG. 17, the terminal device 17 includes: a processor 170, a memory 171, and a computer program 172 stored in the memory 171 and executable on the processor 170, such as an image segmentation program. When the processor 170 executes the computer program 172, the steps in the above-mentioned various radar control method embodiments are implemented, such as S11 to S12 shown in FIG. 3. Alternatively, when the processor 170 executes the computer program 172, the functions of the modules/units in the above-mentioned various terminal device embodiments are implemented, such as the functions of the units 101 to 102 shown in FIG. 16.

Exemplarily, the computer program 172 may be divided into one or more modules/units, which are stored in the memory 171 and executed by the processor 170 to complete the present application. The one or more modules/units may be a series of computer program instruction segments capable of completing specific functions, which are used to describe the execution process of the computer program 172 in the terminal device 17. For example, the computer program 172 may be divided into a first adjustment unit and a control unit. For the specific functions of each unit, please refer to the relevant description in the corresponding embodiment of FIG. 16, which will not be repeated here.

The terminal device may include a processor 170 and a memory 171. The terminal device may include more or fewer components than shown in the figure, or may combine certain components, or different components. For example, the terminal device may also include an input/output device, a network access device, a bus, etc.

The processor 170 may be a central processing unit (CPU), or other general-purpose processors, digital signal processors (DSP), application-specific integrated circuits (ASIC), field-programmable gate arrays (FPGA), or other programmable logic devices, discrete gate or transistor logic devices, discrete hardware components, etc. A general-purpose processor may be a microprocessor or any conventional processor, etc.

The memory 171 may be an internal storage unit of the terminal device 17, such as a hard disk or memory of the terminal device 17. The memory 171 may also be an external storage device of the terminal device 17, such as a plug-in hard disk, a smart media card (SMC), a secure digital (SD) card, a flash card, etc., equipped on the terminal device 17. Further, the memory 171 may also include both an internal storage unit and an external storage device of the terminal device 17. The memory 171 is used to store the computer program and other programs and data required by the terminal device. The memory 171 may also be used to temporarily store data that has been output or is to be output.

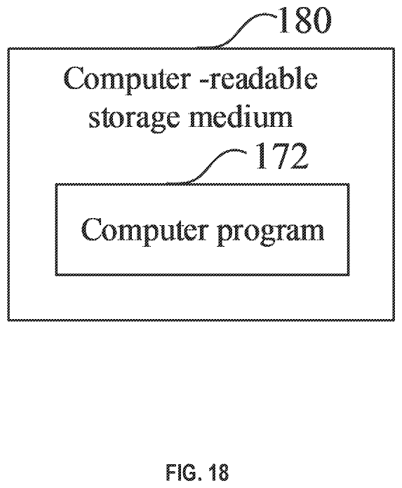

The embodiment of the present application also provides a computer-readable storage medium. Please refer to FIG. 18, which is a schematic diagram of the structure of a computer-readable storage medium provided by an embodiment. As shown in FIG. 18, a computer program 172 is stored in the computer-readable storage medium 180, and the computer program 172 can implement the above radar control method when executed by the processor.

Embodiment of the present application provides a computer program product. When the computer program product runs on a terminal device, the terminal device can implement the above radar control method when executing the computer program product.

In an embodiment, the above-mentioned function allocation can be completed by different functional units and modules as needed, that is, the internal structure of the terminal device can be divided into different functional units or modules to complete all or part of the functions described above. The functional units and modules in the embodiment can be integrated into a processing unit, or each unit can exist physically separately, or two or more units can be integrated into one unit. The above-mentioned integrated unit can be implemented in the form of hardware or in the form of software functional units. In addition, the names of the functional units and modules are only for the convenience of distinguishing each other. The working process of the units and modules in the system can refer to the corresponding process in the aforementioned method embodiment.

The units and algorithm steps of each example described in conjunction with the embodiments disclosed herein can be implemented in electronic hardware, or a combination of computer software and electronic hardware. Whether these functions are performed in hardware or software depends on the application and design constraints of the technical solution.

What is claimed is:

1. A radar control method, comprising:
after completing an emission and reception of a frame of signal, adjusting a scanning order of a LiDAR, so that a scanning order of a current frame of the LiDAR is not all the same as a scanning order of a previous frame of signal; and
controlling the LiDAR to perform an operation of emission and reception on a next frame signal, according to the adjusted scanning order.

2. The radar control method according to claim 1, wherein
after adjusting the scanning order of the LiDAR, the method comprises:
adjusting a scanning time interval; and
controlling the LiDAR to perform the operation of emission and reception on the next frame signal comprises:
controlling the LiDAR to perform the operation of emission and reception on the next frame signal, according to the adjusted scanning order and the adjusted scanning time interval.

3. The radar control method according to claim 1, wherein after adjusting the scanning order of the LiDAR, the method comprises:
adjusting time intervals of multiple emissions and receptions within frames of the LiDAR, so that the time intervals of multiple emissions and receptions are partially or all different.

4. The radar control method according to claim 1, wherein adjusting the scanning order of the LiDAR comprises at least one of the following:
adjusting an emission order of an emitting unit of the LiDAR, or
adjusting a reception order of a receiving unit of the LiDAR.

5. The radar control method according to claim 2, wherein adjusting the scanning time interval comprises at least one of the following:
adjusting an emission time interval between frames, or
adjusting an emission and reception time interval within each frame.

6. The radar control method according to claim 5, wherein adjusting the emission and reception time interval within each frame comprises at least one of the following:
adjusting the emission time interval between two emit blocks in each frame, or
adjusting the reception time interval between two receive blocks in each frame.

7. The radar control method according to claim 5, wherein adjusting the emission time interval between frames comprises at least one of the following:
adjusting a start emission time of each frame, or
adjusting a start emission time of part of the frames,
so that start emission time intervals between two frames are different.

8. A terminal device, comprising a memory, a processor, and a computer program stored in the memory and executable on the processor, wherein when readable instructions of the computer program are executed, the processor performs a radar control method comprising:
after completing an emission and reception of a frame of signal, adjusting a scanning order of a LiDAR, so that a scanning order of a current frame of the LiDAR is not all the same as a scanning order of a previous frame of signal; and
controlling the LiDAR to perform an operation of emission and reception on a next frame signal, according to the adjusted scanning order.

9. A non-transitory computer-readable storage medium, storing a computer program, wherein the computer program, when executed by a processor, causes the processor to perform a radar control method comprising:
after completing an emission and reception of a frame of signal, adjusting a scanning order of a LiDAR, so that a scanning order of a current frame of the LiDAR is not all the same as a scanning order of a previous frame of signal; and
controlling the LiDAR to perform an operation of emission and reception on a next frame signal, according to the adjusted scanning order.
